(19) United States
(12) Patent Application Publication
(10) Pub. No.: US 2024/0429709 A1
(43) Pub. Date: Dec. 26, 2024

(54) CONTROL DEVICE, CONTROL METHOD, AND STORAGE MEDIUM

(71) Applicant: HONDA MOTOR CO., LTD., Tokyo (JP)

(72) Inventors: Takayuki ENOMOTO, Wako-shi (JP); Yasuhiro NAKADA, Wako-shi (JP); Ryuichi KIMATA, Tokyo (JP)

(21) Appl. No.: 18/830,925

(22) Filed: Sep. 11, 2024

Related U.S. Application Data
(63) Continuation of application No. PCT/JP2022/012038, filed on Mar. 16, 2022.

(51) Int. Cl. H02J 1/10; H02J 3/38

(52) U.S. Cl. CPC H02J 1/10; H02J 3/38

(57) ABSTRACT

A device changes a connection state between a plurality of types of power supply sources and a plurality of DC/DC converters. The device specifies switching an operating power supply source, detects excess or insufficiency of power supply, acquires a usage condition of each of the plurality of DC/DC converters, selects at least one DC/DC converter for switching a connection state based on the usage condition and changes the connection state. The device selects a DC/DC converter having the longest accumulated power generation time as at least one DC/DC converter to be disconnected upon specifying that the operating power supply source is switched or detecting that the power supply is excessive, and changes the connection state between the plurality of types of power supply sources and the plurality of DC/DC converters upon switching the operating power supply source.

### CROSS-REFERENCE TO RELATED APPLICATION(S)

This application is a continuation of International Patent Application No. PCT/JP2022/012038 filed on Mar. 16, 2022, the entire disclosures of which are incorporated herein by reference.

### BACKGROUND OF THE INVENTION

### Field of the Invention

The present invention relates to power supply technology in an off-grid, a microgrid, or the like.

### Description of the Related Art

In recent years, an off-grid power supply system has been adopted for a power demand in non-electrified areas and during disasters. In such an off-grid power supply system, power is supplied not from a large-scale power generation facility such as a power plant but from a power supply source such as a solar power generator, an engine generator, or a battery connected to the system. More specifically, in such a power supply system, a DC voltage from each power supply source is converted into a stable and appropriate output DC voltage via a DC/DC converter, and an inverter converts the DC voltage, so that AC power is supplied to a dwelling unit or the like belonging to the system.

In a general conventional power supply system, a dedicated DC/DC converter is provided for each power supply source, but the DC/DC converter has a large scale corresponding to the maximum output (10 KW or the like) of the power supply source, and can increase the cost at the time of introduction or replacement of the power supply system. In this regard, Japanese Patent Laid-Open No. 2016-106523 discloses technology in which two DC/DC converters are connected in parallel to a power amplifier, and whether to operate both or only one of the DC/DC converters (one of the DC/DC converters is turned off) is varied according to the magnitude of the current consumption of the power amplifier. According to this technology, it is possible to realize output according to a power demand while reducing the scale of each DC/DC converter.

Incidentally, Japanese Patent Laid-Open No. 2016-106523 refers not only to two DC/DC converters but also to a mode in which a plurality of DC/DC converters are connected in parallel, but does not make any assumption as to which of the DC/DC converters should be operated according to the power demand.

### SUMMARY OF THE INVENTION

The present invention realizes long-term stable power supply while reducing the introduction cost and the frequency of occurrence of failures.

The present invention in its first aspect provides a control device that changes a connection state between a plurality of types of power supply sources in which which power supply source is operated is controlled and a plurality of DC/DC converters, the control device comprising: a specifying unit configured to specify that an operating power supply source among the plurality of types of power supply sources is switched; a detection unit configured to detect excess or insufficiency of power supply with respect to a power demand; an acquisition unit configured to acquire a usage condition of each of the plurality of DC/DC converters; a selection unit configured to select at least one DC/DC converter for switching a connection state based on the usage condition; and a first control unit configured to change the connection state between the plurality of types of power supply sources and the plurality of DC/DC converters based on a selection result by the selection unit, wherein the usage condition includes an accumulated power generation time of the DC/DC converter, and the selection unit selects a DC/DC converter having the longest accumulated power generation time from among the DC/DC converters connected to the plurality of types of power supply sources as at least one DC/DC converter to be disconnected, when it is specified by the specifying unit that the operating power supply source is switched or when it is detected by the detection unit that the power supply is excessive, and the first control unit changes the connection state between the plurality of types of power supply sources and the plurality of DC/DC converters based on the selection result, when it is specified by the specifying unit that the operating power supply source is switched.

The present invention in its second aspect provides a control method for changing a connection state between a plurality of types of power supply sources in which which power supply source is operated is controlled and a plurality of DC/DC converters, the control method being executed by a control device and comprising: specifying that an operating power supply source among the plurality of types of power supply sources is switched; detecting excess or insufficiency of power supply with respect to a power demand; acquiring a usage condition of each of the plurality of DC/DC converters; selecting at least one DC/DC converter for switching a connection state based on the usage condition; and changing the connection state between the plurality of types of power supply sources and the plurality of DC/DC converters based on a selection result in the selection, wherein the usage condition includes an accumulated power generation time of the DC/DC converter, when it is specified in the specifying that the operating power supply source is switched or when it is detected in the detection that the power supply is excessive, a DC/DC converter having the longest accumulated power generation time is selected as at least one DC/DC converter to be disconnected from among the DC/DC converters connected to the plurality of types of power supply sources in the selection, and when it is specified in the specifying that the operating power supply source is switched, the connection state between the plurality of types of power supply sources and the plurality of DC/DC converters is changed based on the selection result in the control.

The present invention in its third aspect provides a computer-readable storage medium storing a program for causing a computer that changes a connection state between a plurality of types of power supply sources in which which power supply source is operated is controlled and a plurality of DC/DC converters to execute: specifying that an operating power supply source among the plurality of types of power supply sources is switched; detecting excess or insufficiency of power supply with respect to a power demand; an acquisition process of acquiring a usage condition of each of the plurality of DC/DC converters; selecting at least one DC/DC converter for switching a connection state based on the usage condition; and changing the connection state between the plurality of types of power supply sources and the plurality of DC/DC converters based on a selection result by the selection, wherein the usage condition includes an accumulated power generation time of the DC/DC converter, when it is specified in the specifying that the operating power supply source is switched or when it is detected in the detection that the power supply is excessive, a DC/DC converter having the longest accumulated power generation time is selected as at least one DC/DC converter to be disconnected from among the DC/DC converters connected to the plurality of types of power supply sources in the selection, and when it is specified in the specifying that the operating power supply source is switched, the connection state between the plurality of types of power supply sources and the plurality of DC/DC converters is changed based on the selection result in the control.

Other features and advantages of the present invention will be apparent from the following description taken in conjunction with the accompanying drawings. Note that the same reference numerals denote the same or like components throughout the accompanying drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1A is a schematic diagram of a power supply system;

FIG. 1B is a schematic diagram of a connection unit 131;

FIG. 2 is a block diagram illustrating a hardware configuration of a control device 100;

FIG. 3 is a diagram illustrating converter information managed by a converter DB 110;

FIG. 4 is a diagram illustrating a time transition of power supply corresponding to a power demand of the power supply system;

FIG. 5 is a diagram illustrating drooping characteristics of output voltages at the downstream of a plurality of DC/DC converters 132;

FIG. 6 is a flowchart illustrating a connection state control process executed by the control device 100 according to the first embodiment;

FIG. 7 is a flowchart illustrating a process during insufficiency executed by the control device 100 according to the first embodiment; and

FIG. 8 is a flowchart illustrating a process during excess executed by the control device 100 according to the first embodiment.

### DESCRIPTION OF THE EMBODIMENTS

### First Embodiment

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

An embodiment described below describes an example in which the present invention is applied to a control device capable of controlling connection states of a plurality of DC/DC converters that can be selectively connected to a power supply source in an off-grid power supply system to which a plurality of types of power supply sources belong as an example of a management device. However, the present invention is applicable to any device capable of controlling connection of a plurality of DC/DC converters to any DC power supply and outputting power.

### <<Configuration of Power Supply System>>

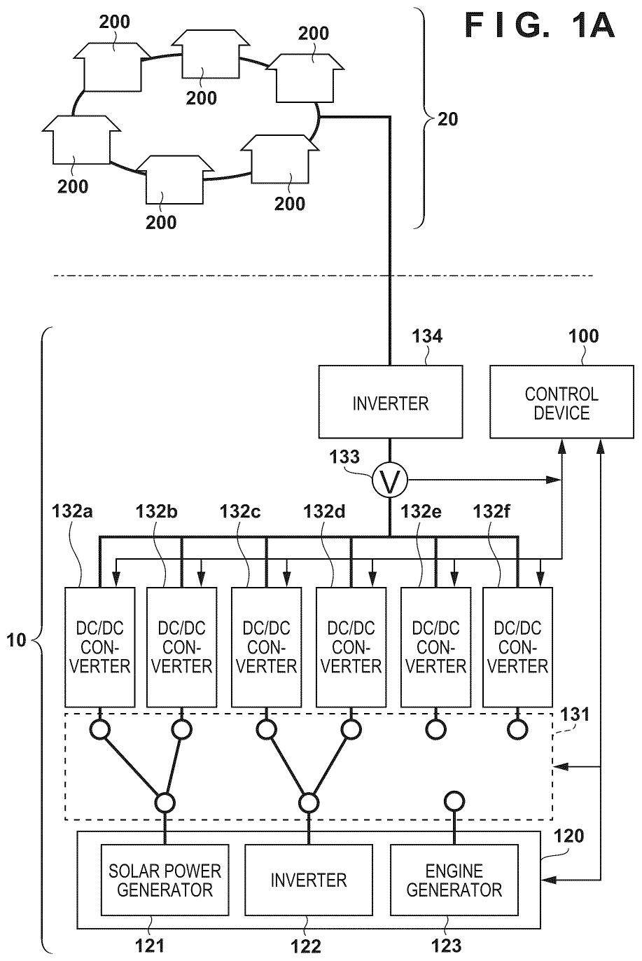

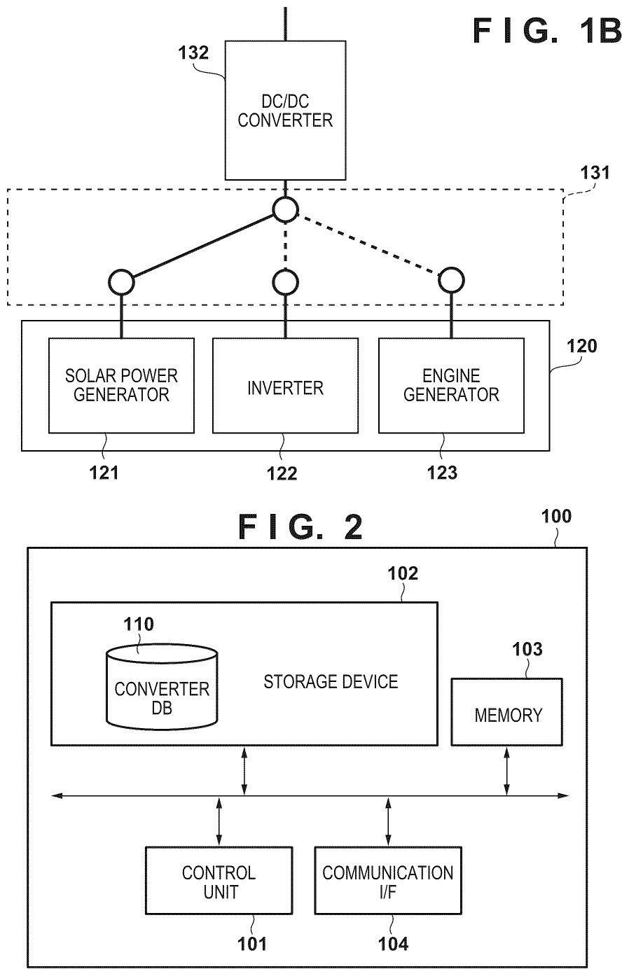

FIG. 1A is a diagram illustrating a configuration of a power supply system according to the present embodiment. As illustrated in FIG. 1A, the power supply system is illustrated separately by a supply side 10 indicating a facility that supplies power and a demand side 20 that consumes the supplied power. The demand side 20 includes one or more dwelling units 200 used by consumers. The consumer can connect an arbitrary load to an outlet in each dwelling unit 200 and operate and use the load using supply power.

In the power supply system of the present embodiment, a description will be given on the assumption that the supply side 10 is provided with a solar power generator 121, a battery 122, and an engine generator 123 as a power supply source 120 so as to be usable. However, the embodiment of the present invention is not limited thereto, and it goes without saying that a generator of an arbitrary power generation system functioning as a DC power supply, other facilities, and the like may be included. It is assumed that the operation of the power supply source 120 is controlled such that, for example, the solar power generator 121 mainly supplies power during the day when the weather is good, the solar power generator 121 and the battery 122 supply power during the day when the weather is cloudy, and the battery 122 and the engine generator 123 supply power during the rainy weather or at night.

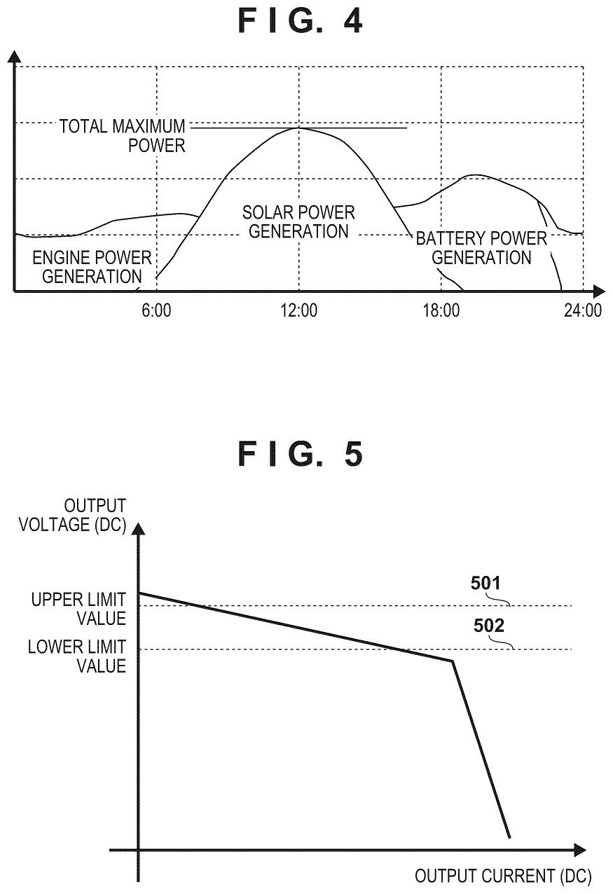

A DC/DC converter 132 that converts the output of the power supply source 120 into a stable DC voltage is connected to the operating power supply source 120. As the DC/DC converter 132, the power supply system of the present embodiment is not provided with one DC/DC converter 132 having a scale corresponding to the maximum power for each power supply source 120 (the solar power generator 121, the battery 122, and the engine generator 123), but is provided with DC/DC converters 132 having a smaller scale. For example, as illustrated in FIG. 4, maximum output power of each DC/DC converter 132 is set to about ½ to 1/10 of a peak, that is, a maximum value of a total value of power consumption per hour in consideration of the time transition of the power supply corresponding to the power demand of the power supply system. Therefore, a necessary number of DC/DC converters 132 are connected to the operating power supply source 120 such that power corresponding to a load situation connected to the demand side 20 is output from the supply side 10. In order to enable such output control, a connection unit 131 is provided between the power supply source 120 and the DC/DC converter 132. In the present embodiment, in order to facilitate understanding of the invention, all of the plurality of DC/DC converters 132 will be described as the same products having the same performance.

As illustrated in FIG. 1B, the connection unit 131 is configured to be able to connect the input of each of the DC/DC converters 132 to any of the solar power generator 121, the battery 122, and the engine generator 123 provided as the power supply source 120. Therefore, in the aspect illustrated in FIG. 1A, among the six DC/DC converters 132 illustrated as examples, DC/DC converters 132a and 132b are connected to the solar power generator 121, and DC/DC converters 132c and 132d are connected to the battery 122. The connection in the connection unit 131, that is, which DC/DC converter 132 is connected to which power supply source 120 is controlled by a control device 100.

Outputs of one or more DC/DC converters 132 connected to the power supply source 120 are integrated and input to an inverter 134. The inverter 134 converts the input DC voltage into an AC voltage defined for the demand side 20. In the power supply system of the present embodiment, in order to detect excess or insufficiency of the power supply on the supply side 10 with respect to the power demand related to the demand side 20, a voltmeter 133 is provided on the input side of the inverter 134, that is, the downstream of the plurality of DC/DC converters 132.

The control device 100, the connection unit 131, the DC/DC converter 132, and the voltmeter 133 are configured to be able to transmit and receive information by an arbitrary communication system. The control device 100 controls a change of the connection state of each DC/DC converter 132 in the connection unit 131, based on the output of the voltmeter 133 and the usage condition of each DC/DC converter 132. In addition, the control device 100 controls the power generation amount of the DC/DC converter 132 connected to the power supply source 120.

Hereinafter, a hardware configuration involved in implementation of the present invention will be further described with reference to the drawings.

### <Hardware Configuration of Control Device 100>

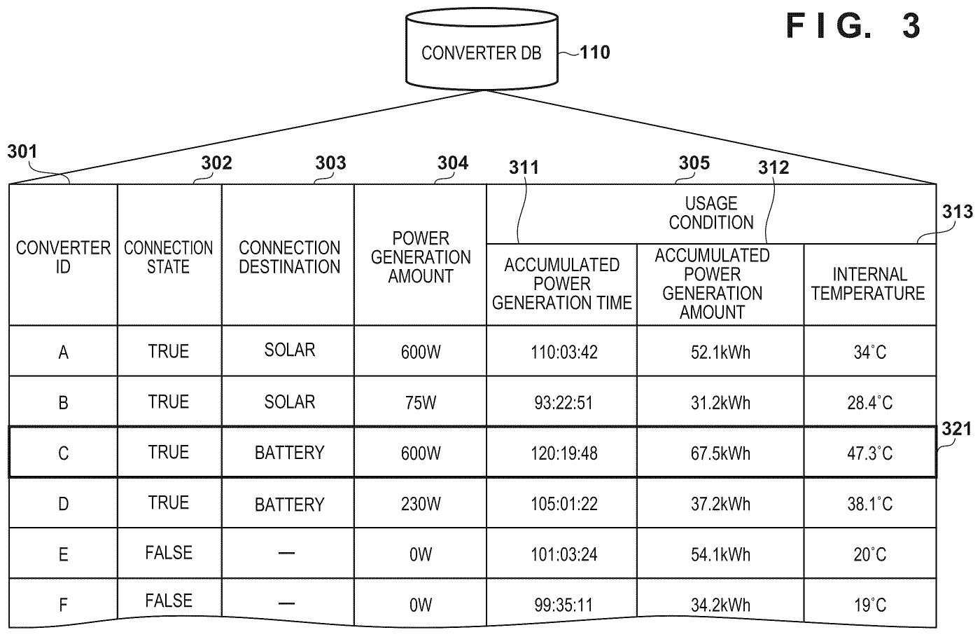

First, a hardware configuration of the control device 100 of the present embodiment will be described with reference to a block diagram of FIG. 2. A control unit 101 is a processor represented by a CPU, and implements operation control of each block and various functions to be described later by developing a program recorded in a storage device 102 in a memory 103 and executing the program. The storage device 102 is a nonvolatile storage device capable of permanently storing information, such as a ROM or an HDD. Here, the program executed by the control unit 101 may be installed in the storage device 102 of the control device 100 via a storage medium such as a CD-ROM. The memory 103 is a volatile storage device such as a RAM, and is used not only as a development area of a program or a work area of a function but also as a storage area in which information output by the operation of each block is temporarily recorded. A communication I/F 104 is an interface for performing information communication with an external device, and performs information communication with the connection unit 131, the DC/DC converter 132, and the voltmeter 133 in the present embodiment.

In addition to the program executed by the control unit 101, the storage device 102 includes a converter DB 110 that manages various types of information (converter information) related to the plurality of DC/DC converters 132 on the supply side 10. In order to simplify the description, it is assumed that the control device 100 of the present embodiment sequentially receives information indicating the state of each DC/DC converter 132 and updates the corresponding converter information.

### <Converter Information>

As illustrated in FIG. 3, for example, each record of the converter information managed for each DC/DC converter 132 by the converter DB 110 includes a converter ID 301, a connection state 302, a connection destination 303, a power generation amount 304, and a usage condition 305.

Here, the converter ID 301 is identification information that uniquely identifies each of the DC/DC converters 132. The connection state 302 is information indicating whether or not the DC/DC converter 132 is connected to any power supply source 120. The connection state 302 may be, for example, boolean type information, and when the connection state 302 is “true”, it indicates that the DC/DC converter 132 is connected to any power supply source 120, and when the connection state 302 is “false”, it indicates that the DC/DC converter 132 is not connected to any power supply source 120. Whether or not the DC/DC converter 132 is connected to any power supply source 120 may be determined based on, for example, information of a current power generation amount (output) of the DC/DC converter 132 acquired from the DC/DC converter 132. The information of the power generation amount is stored in the power generation amount 304. When the connection state 302 is true, information for identifying the power supply source 120 to which the DC/DC converter 132 is connected is stored in the connection destination 303.

The usage condition 305 is information for evaluating a deterioration state or a failure possibility of the corresponding DC/DC converter 132. In the present embodiment, the usage condition 305 includes: an accumulated power generation time 311 indicating an accumulated time for which the DC/DC converter 132 is connected to any power supply source 120 to generate power (from the time of introduction to the present); an accumulated power generation amount 312 indicating a sum of power generation amounts of the DC/DC converter 132 (from the time of introduction to the present); and an internal temperature 313 indicating a current internal temperature of the DC/DC converter 132. In the present embodiment, it is assumed that the control device 100 can intermittently receive, from each DC/DC converter 132, information of the current internal temperature indicated by a thermometer provided inside in addition to the information of the current power generation amount described above, as usage condition information. Therefore, the control unit 101 updates the internal temperature 313 of the corresponding converter information based on the information of the current internal temperature of the received usage condition information. Further, when the information of the current power generation amount indicates a significant value (for example, positive) in the usage condition information received from each DC/DC converter 132, the control unit 101 may update the accumulated power generation time 311 by sequentially adding a value for a predetermined time (for example, an acquisition interval of the usage condition information) to the value of the accumulated power generation time 311 of the corresponding converter information. In addition, the accumulated power generation amount 312 may be updated by the control unit 101 sequentially adding the value of the current power generation amount to the value of the accumulated power generation amount 312 of the corresponding converter information when the information of the current power generation amount indicates a significant value in each DC/DC converter 132.

For example, a record 321 illustrated in FIG. 3 indicates converter information related to the DC/DC converter 132 whose converter ID 301 is “C”. The information of the connection state 302, the connection destination 303, and the power generation amount 304 indicates that the DC/DC converter 132 is currently connected to the battery 122 to output 600 W. In addition, it can be grasped from the information of the usage condition 305 that the accumulated power generation time of the DC/DC converter 132 is 120 hours, 19 minutes, and 48 seconds, the accumulated power generation amount is 67.5 kWh, and the internal temperature is 47.3° C.

### <<Outline of Connection State Control>>

Hereinafter, an outline of connection state control for changing the connection state of the plurality of DC/DC converters 132 in the power supply system of the present embodiment will be described.

In the power supply system of the present embodiment, the control unit 101 performs control related to the change of the connection state of the plurality of DC/DC converters 132 to the power supply source 120 according to the power demand on the demand side 20. More specifically, the control unit 101 detects whether there is excess or insufficiency in the power supply with respect to the power demand, and performs control to increase the power generation amount of the connected DC/DC converter 132 or connect a new DC/DC converter 132 to the operating power supply source 120 in a case where the power supply is insufficient, thereby increasing the supply power. Conversely, in a case where the power supply is excessive, the control unit 101 performs control to decrease the power generation amount of the connected DC/DC converter 132 or disconnect the DC/DC converter 132 from the operating power supply source 120, thereby decreasing the supply power.

As described above, in the power supply system of the present embodiment, the control unit 101 determines whether excess or insufficiency of the power supply occurs based on the output (output voltage) of the voltmeter 133. FIG. 5 illustrates drooping characteristics of the output voltages at the downstream of the plurality of DC/DC converters 132. The power supply system is operated such that the power consumption of the load of the demand side 20 and the output of the supply side 10 (the sum (supply power) of the power generation amounts of the plurality of DC/DC converters 132) are balanced. However, in a case where the power consumption on the demand side 20 rapidly increases due to connection of a new load or the like and the balance is lost (unbalanced state), a current (output current) flowing from the supply side 10 to the demand side 20 increases. In a case where the output current increases without changing the power generation amount on the supply side 10, as illustrated in FIG. 5, the output voltage decreases, so that problems such as unstable operation of the load connected to the demand side 20 and stop of the operation of the load may occur, and the power supply system cannot perform suitable power supply. In particular, when the output current exceeds a certain value, the output voltage steeply decreases as illustrated in the drawing. Therefore, the supply side 10 needs to increase the supply power so as to be balanced with the increased power consumption.

The unbalanced state also occurs when the power consumption of the demand side 20 decreases due to the release of the load connection or the like. That is, when the power consumption decreases, the output voltage becomes too high as illustrated in FIG. 5 because the power supply is continued with an excessive power generation amount although the output current decreases.

Therefore, in the present embodiment, the control unit 101 brings a value range of the output voltage having a small increase/decrease with respect to the change in the output current into a state where the power consumption and the supply power are balanced, and detects excess or insufficiency of the power supply with respect to the power demand based on whether or not a measurement result of the voltmeter 133 is included in the value range. The value range may be defined by an upper limit value 501 and a lower limit value 502 as illustrated in FIG. 5. When the output voltage received from the voltmeter 133 falls below the lower limit value 502, the control unit 101 detects that the power supply is insufficient. When the output voltage received from the voltmeter 133 exceeds the upper limit value 501, the control unit 101 detects that the power supply is excessive. When the output voltage received from the voltmeter 133 falls within the range from the lower limit value 502 to the upper limit value 501, the control unit 101 detects that excess or insufficiency of the power supply occurs does not occur.

Hereinafter, details of control executed when excess or insufficiency of the power supply with respect to the power demand is detected will be described. Prior to the following control, it is assumed that usage condition information is received from each DC/DC converter 132, and the converter information is updated to content reflecting the usage condition information.

<Control during Insufficient Power Supply>

As described above, the insufficiency of the power supply is eliminated by increasing the power generation amount of the DC/DC converter 132 (hereinafter, referred to as a connected converter) connected to the operating power supply source 120 (hereinafter, referred to as an operation power supply), or connecting a new DC/DC converter 132 (hereinafter, referred to as an additional converter) to the operation power supply.

In the power supply system of the present embodiment, since the power supply is suitably realized with a minimum number of DC/DC converters 132, the latter handling method is performed only when all of the connected converters perform the output with the maximum power generation amount. In other words, when the output of the connected converter last connected to the operation power supply does not reach the maximum power generation amount, the control unit 101 first increases the power generation amount of the converter, that is, performs the former handling method. That is, when it is detected that the power supply is insufficient in a state where all of the connected converters do not perform the output with the maximum power generation amount, the control unit 101 performs control to sequentially increase the power generation amount of the connected converter last connected to the operation power supply, and attempts to eliminate the insufficiency of the power supply. At this time, when the excess or insufficiency of the power supply does not occur due to the increase in the power generation amount of the connected converter last connected to the operation power supply, the control unit 101 performs control to maintain the power generation amount of the converter at a value at that time.

In addition, in a case where the insufficiency of the power supply is not eliminated even when the connected converter last connected to the operation power supply reaches the maximum power generation amount by such control, or in a case where it is detected that the power supply is insufficient in a state where all of the connected converters have the maximum power generation amount, the control unit 101 performs control to newly connect the additional converter and sequentially increase the power generation amount of the additional converter, and attempts to eliminate the insufficiency of the power supply.

Here, the selection of the additional converter is performed based on a usage condition of each of the DC/DC converters 132 (hereinafter, referred to as unconnected converters) not connected to the operation power supply. That is, the control unit 101 evaluates each of the unconnected converters based on the usage condition, and selects one converter among the unconnected converters as the additional converter based on an evaluation result. In the present embodiment, the control unit 101 evaluates the usage condition of each of the unconnected converters from the following three viewpoints.

The first viewpoint is the accumulated power generation time. As the power generation time of the DC/DC converter increases, the deterioration of the DC/DC converter progresses, and the DC/DC converter easily fails. For example, when the same DC/DC converter 132 is frequently selected as the additional converter, the accumulated power generation time of the converter tends to be long, and as a result, a failure of the converter easily occurs, and it becomes difficult to realize stable and suitable power supply. Therefore, from this viewpoint, the control unit 101 compares the values of the accumulated power generation time 311 of the converter information related to the unconnected converters, and selects the converter indicating the shortest accumulated power generation time as the additional converter. As a result, it can be expected that the deterioration situation of the DC/DC converter 132 is caused to be uniform.

The second viewpoint is the accumulated power generation amount. Similarly to the power generation time, as the power generation amount of the DC/DC converter increases, the deterioration of the DC/DC converter progresses, and the DC/DC converter easily fails. Therefore, from this viewpoint, the control unit 101 compares the values of the accumulated power generation amount 312 of the converter information related to the unconnected converters, and selects the converter indicating the smallest accumulated power generation amount as the additional converter. As a result, it can be expected that the deterioration situation of the DC/DC converter 132 is caused to be uniform.

The third viewpoint is the internal temperature. When the DC/DC converter generates heat by its operation and the internal temperature increases, a loss occurs and voltage conversion efficiency decreases. In addition to the DC/DC converter, in many devices, when heat is generated by the operation and the internal temperature increases, the probability of occurrence of failure or malfunction increases. Therefore, from this viewpoint, the control unit 101 compares the values of the internal temperature 313 of the converter information related to the unconnected converters, and selects the converter indicating the lowest internal temperature among the values as the additional converter. As a result, it can be expected to reduce an occurrence rate of failure or malfunction of the DC/DC converter 132 while avoiding a decrease in conversion efficiency.

Since these viewpoints all evaluate the usage condition of the DC/DC converter 132 based on different criteria to determine an additional converter, the control unit 101 gives priority to these viewpoints and selects one additional converter from the unconnected converters. Specifically, the control unit 101 determines an additional converter from among the plurality of unconnected converters in the order of priority of a converter having a short accumulated power generation time, a converter having a small accumulated power generation amount, and a converter having a low internal temperature. For example, the control unit 101 first specifies an unconnected converter having the shortest accumulated power generation time based on the first viewpoint. At this time, when there is one unconnected converter, the control unit 101 selects the converter as the additional converter. On the other hand, when there are a plurality of unconnected converters, that is, when there are converters having the same accumulated power generation time, the control unit 101 specifies a converter having the smallest accumulated power generation amount based on the second viewpoint. When there is one unconnected converter, the control unit 101 selects the converter as the additional converter, and when there are a plurality of unconnected converters, the control unit 101 performs the evaluation based on the third viewpoint, and selects the additional converter.

<Control during Excessive Power Supply>

As described above, the excess of the power supply is eliminated by decreasing the power generation amount of the connected converter or disconnecting any connected converter from the operation power supply.

When the DC/DC converter 132 connected to the operation power supply is disconnected, it is preferable that the converter is not generating power or the power generation amount is small. This is to avoid an occurrence of malfunction or operation stop of a load connected to the demand side 20 due to a sudden decrease in the power generation amount due to disconnection of the connected converter during power generation, and to reduce an influence on various circuits including the DC/DC converter. Therefore, even in a case where the excess of the power supply is handled by the latter method, it is basically necessary to perform handling by the former method as the control in the previous stage. That is, in order to disconnect any connected converter from the operation power supply, it is necessary to reduce the power generation amount of the converter to a disconnectable value (hereinafter, referred to as a minimum power generation amount). In other words, at the time of starting the control related to the elimination of the excess of the power supply, the control unit 101 needs to select the connected converter (hereinafter, referred to as a candidate converter) to be disconnected next and perform control to reduce the power generation amount of the converter, regardless of whether or not it will be ultimately disconnected.

Specifically, when it is detected that the power supply is excessive, the control unit 101 first selects a candidate converter. Then, the control unit 101 performs control to sequentially reduce the power generation amount of the candidate converter, and attempts to eliminate the excess of the power supply. At this time, in a case where the excess of the power supply does not occur due to the decrease in the power generation amount of the candidate converter, the control unit 101 performs control to maintain the power generation amount at the value at that time without disconnecting the candidate converter.

In addition, in a case where the excess of the power supply is not eliminated even when the power generation amount of the candidate converter reaches the minimum power generation amount by such control, or in a case where it is detected that the power supply is excessive in a state where the candidate converter has the minimum power generation amount, the control unit 101 performs control to disconnect the candidate converter and attempts to eliminate the excess of the power supply. That is, the control unit 101 selects the candidate converter as a connected converter to be ultimately disconnected, and controls disconnection.

The selection of the candidate converter is performed based on the usage condition of each of the connected converters at the time of starting the control related to the elimination of the excess of the power supply. That is, the control unit 101 evaluates each of the connected converters based on the usage condition, and selects one converter among the connected converters as the candidate converter based on an evaluation result. In the present embodiment, the control unit 101 evaluates the usage condition of each of the connected converters from the following three viewpoints.

The first viewpoint is the accumulated power generation time. From this viewpoint, the control unit 101 compares the values of the accumulated power generation time 311 of the converter information related to the connected converters, and selects the converter indicating the longest accumulated power generation time as the candidate converter. As a result, it can be expected that the deterioration situation of the DC/DC converter 132 is caused to be uniform.

The second viewpoint is the accumulated power generation amount. From this viewpoint, the control unit 101 compares the values of the accumulated power generation amount 312 of the converter information related to the connected converters, and selects the converter indicating the largest accumulated power generation amount as the candidate converter. As a result, it can be expected that the deterioration situation of the DC/DC converter 132 is caused to be uniform.

The third viewpoint is the internal temperature. From this viewpoint, the control unit 101 compares the values of the internal temperature 313 of the converter information related to the connected converters, and selects the converter indicating the highest internal temperature among them as the candidate converter. As a result, it can be expected to reduce an occurrence rate of failure or malfunction of the DC/DC converter 132 while avoiding a decrease in conversion efficiency.

Since these viewpoints all evaluate the usage condition of the DC/DC converter 132 based on different criteria to determine a candidate converter, the control unit 101 gives priority to these viewpoints and selects one candidate converter from the connected converters. Specifically, the control unit 101 determines a candidate converter from among the plurality of connected converters in the order of priority of a converter having a long accumulated power generation time, a converter having a large accumulated power generation amount, and a converter having a high internal temperature. For example, the control unit 101 first specifies a connected converter having the longest accumulated power generation time based on the first viewpoint. At this time, when there is one connected converter, the control unit 101 selects the converter as the candidate converter. On the other hand, when there are a plurality of connected converters, that is, when there are converters having the same accumulated power generation time, the control unit 101 specifies a converter having the largest accumulated power generation amount based on the second viewpoint. When there is one connected converter, the control unit 101 selects the converter as the candidate converter, and when there are a plurality of connected converters, the control unit 101 performs the evaluation based on the third viewpoint, and selects the candidate converter.

By such connection state control, when excess or insufficiency of the power supply with respect to the power demand is detected, the deterioration situations of the plurality of DC/DC converters 132 can be caused to be uniform, and a decrease in conversion efficiency and an occurrence rate of the failure or malfunction can be reduced. As a result, the life of the power supply system can be extended.

### <<Connection State Control Process>>

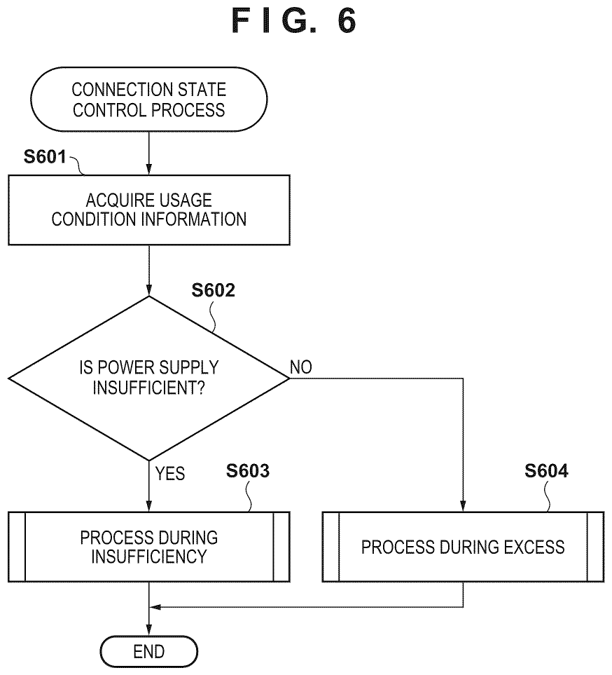

Hereinafter, a specific process of a connection state control process performed when excess or insufficiency of the power supply with respect to the power demand is detected in the control device 100 of the present embodiment will be described with reference to a flowchart of FIG. 6. The process corresponding to the flowchart can be realized by the control unit 101, for example, reading a corresponding process program recorded in the storage device 102, developing the process program in the memory 103, and executing the process program. This connection state control process will be described as being started when the control unit 101 determines that the output voltage received from the voltmeter 133 is not included in a voltage value range determined for a state where the power consumption and the supply power are balanced.

In S601, the control unit 101 acquires the usage condition information of each of the plurality of DC/DC converters 132 via the communication I/F 104 and updates the converter information.

In S602, the control unit 101 determines whether or not the power supply with respect to the power demand is insufficient. That is, the control unit 101 determines whether or not the output voltage received from the voltmeter 133 falls below the lower limit value 502. When it is determined that the power supply is insufficient, the control unit 101 causes the process to proceed to S603. When it is determined that the power supply is not insufficient, that is, the power supply is excessive, the control unit 101 causes the process to proceed to S604.

In S603, the control unit 101 executes a process during insufficiency of performing control related to the insufficiency of the power supply, and when the execution of the process during insufficiency ends, the control unit 101 completes this connection state control process.

### <Process During Insufficiency>

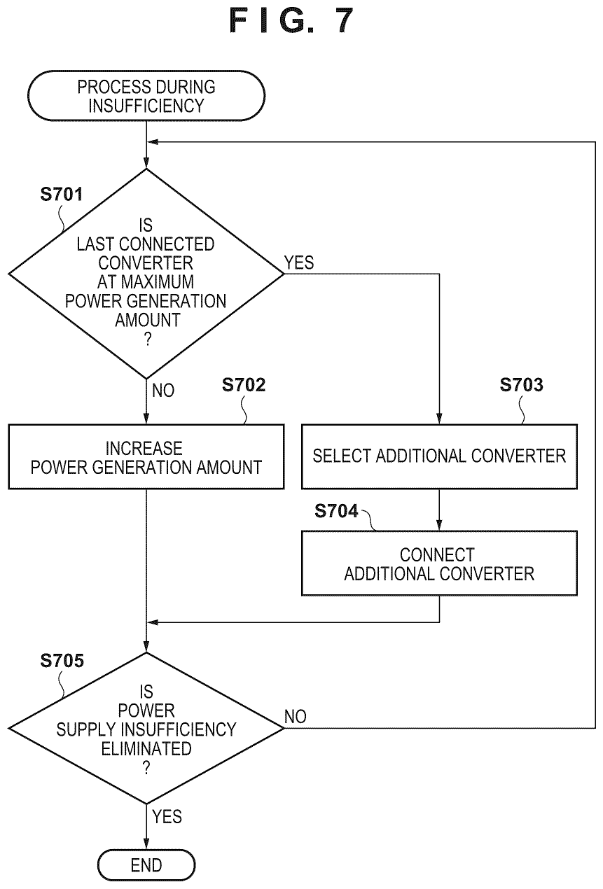

Here, details of the process during insufficiency executed in this step will be described with further reference to a flowchart of FIG. 7.

In S701, the control unit 101 determines whether or not the output of the connected converter last connected to the operation power supply reaches the maximum power generation amount. The determination of this step is performed by the control unit 101 referring to the power generation amount 304 of the converter information related to the corresponding connected converter. Here, it is assumed that the information of the maximum power generation amount of each DC/DC converter 132 is stored in advance in the storage device 102, for example. When it is determined that the output of the connected converter last connected reaches the maximum power generation amount, the control unit 101 causes the process to proceed to S703, and when it is determined that the output does not reach the maximum power generation amount, the control unit 101 causes the process to proceed to S702.

In S702, the control unit 101 performs control to increase the power generation amount of the connected converter last connected to the operation power supply by one stage. The control of this step is realized by the control unit 101 constituting an output control command and transmitting the output control command to the corresponding connected converter via the communication I/F 104. When the control is completed, the control unit 101 causes the process to proceed to S705.

On the other hand, when it is determined in S701 that the output of the connected converter last connected to the operation power supply reaches the maximum power generation amount, the control unit 101 selects an additional converter based on the usage condition of each of the unconnected converters, in S703.

In S704, the control unit 101 performs control to connect the additional converter selected in S703 to the operation power supply. The control of this step is realized by the control unit 101 constituting a connection command and transmitting the connection command to the connection unit 131 via the communication I/F 104. When the control is completed, the control unit 101 causes the process to proceed to S705.

In S705, the control unit 101 determines whether or not the insufficiency of the power supply with respect to the power demand has been eliminated. The determination of this step may be made by the control unit 101 based on whether or not the output voltage received from the voltmeter 133 has exceeded the lower limit value 502. The control unit 101 completes this process during insufficiency when it is determined that the insufficiency of the power supply has been eliminated, and returns the process to S701 when it is determined that the insufficiency has not been eliminated.

On the other hand, when it is determined in S602 of the connection state control process that the power supply with respect to the power demand is excessive, the control unit 101 executes a process during excess of performing control related to the excess of the power supply in S604, and when the execution of the process during excess ends, the control unit 101 completes this connection state control process.

### <Process During Excess>

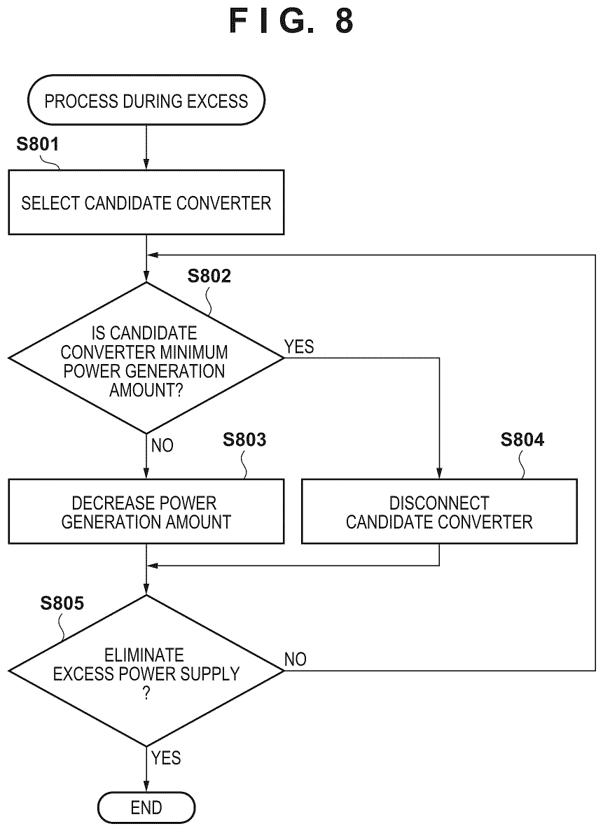

Here, details of the process during excess executed in this step will be described with further reference to a flowchart of FIG. 8.

In S801, the control unit 101 selects a candidate converter based on the usage condition of each of the connected converters.

In S802, the control unit 101 determines whether or not the output of the candidate converter reaches the minimum power generation amount. The determination of this step is performed by the control unit 101 referring to the power generation amount 304 of the converter information related to the candidate converter. Here, it is assumed that the information of the minimum power generation amount of each DC/DC converter 132 is stored in the storage device 102 in advance, for example, similarly to the maximum power generation amount. When it is determined that the output of the candidate converter reaches the minimum power generation amount, the control unit 101 causes the process to proceed to S804, and when it is determined that the output does not reach the minimum power generation amount, the control unit 101 causes the process to proceed to S803.

In S803, the control unit 101 performs control to decrease the power generation amount of the candidate converter by one stage. The control of this step is realized by the control unit 101 constituting an output control command and transmitting the output control command to the candidate converter via the communication I/F 104. When the control is completed, the control unit 101 causes the process to proceed to S805.

On the other hand, when it is determined in S802 that the output of the candidate converter reaches the minimum power generation amount, the control unit 101 performs control to disconnect the candidate converter from the operation power supply in S804. The control of this step is realized by the control unit 101 constituting a disconnection command and transmitting the disconnection command to the connection unit 131 via the communication I/F 104. When the disconnection is completed, the control unit 101 causes the process to proceed to S805.

In S805, the control unit 101 determines whether or not the excess of the power supply with respect to the power demand has been eliminated. The determination of this step may be made by the control unit 101 based on whether or not the output voltage received from the voltmeter 133 has fallen below the upper limit value 501. When it is determined that the excess of the power supply has been eliminated, the control unit 101 completes this process during excess, and when it is determined that the excess has not been eliminated, the control unit returns the process to S802. When the excess of the power supply is not eliminated even if the candidate converter is disconnected from the operation power supply, the control unit 101 selects a new candidate converter and performs the process of S802.

In this way, according to the control device of the present embodiment, it is possible to realize long-term stable power supply while reducing the introduction cost and the occurrence frequency of the failure. More specifically, when the power supply with respect to the power demand is insufficient, the control device can preferentially select the DC/DC converter, which has a low degree of progress of deterioration and can be operated well, as the connection target to the power supply source, based on the usage condition of each DC/DC converter. In addition, when the power supply with respect to the power demand is excessive, the control device can preferentially select the DC/DC converter, which has a high degree of progress of deterioration and may be unstably operated, as the disconnection target from the power supply source.

In the present embodiment, an aspect has been described in which one DC/DC converter is selected as the additional converter or the candidate converter so as to realize suitable power supply using the minimum number of DC/DC converters 132, but the implementation of the present invention is not limited thereto. For example, in a case where excess or insufficiency of the power supply with respect to the power demand is detected, the control unit 101 may select two or more DC/DC converters based on the usage condition of the target DC/DC converter. In this case, the control unit 101 may perform control to select at least the DC/DC converter specified by the evaluation criteria described above.

In addition, in the process during insufficiency of the present embodiment, it has been described that the additional converter is selected when the outputs of all the connected converters reach the maximum power generation amount, but the implementation of the present invention is not limited thereto. For example, similarly to the process during excess, the control unit 101 may determine the additional converter before the output of the connected converter last connected to the operation power supply reaches the maximum power generation amount, based on the usage condition of each of the unconnected converters at the time of starting the control related to the elimination of the insufficiency of the power supply.

### First Modification

In the embodiment described above, for each of the case where the power supply with respect to the power demand is insufficient and the case where the power supply is excessive, the usage condition of the DC/DC converter is evaluated from three types of viewpoints, and the converter for switching the connection state is selected. However, the implementation of the present invention is not limited thereto. The usage condition of the DC/DC converter may not be evaluated in a decoding manner from three types of viewpoints, but may be evaluated from only one of the viewpoints.

For example, in a case where the power supply is insufficient, the control unit 101 may evaluate the usage condition of the unconnected converter only with the accumulated power generation time, and determine at least a converter having the shortest accumulated power generation time as the additional converter. Further, for example, in a case where the power supply is excessive, the control unit 101 may evaluate the usage condition of the connected converter only with the accumulated power generation time, and determine at least a converter having the longest accumulated power generation time as the candidate converter. Further, for example, in a case where the power supply is insufficient, the control unit 101 may evaluate the usage condition of the unconnected converter only with the accumulated power generation amount, and determine at least a converter having the smallest accumulated power generation amount as the additional converter. Further, for example, in a case where the power supply is excessive, the control unit 101 may evaluate the usage condition of the connected converter only with the accumulated power generation amount, and determine at least a converter having the largest accumulated power generation amount as the candidate converter. As a result, it is possible to realize operation in which the life of the power supply system is extended while causing the deterioration situations of the plurality of DC/DC converters to be uniform.

Further, for example, in a case where the power supply is insufficient, the control unit 101 may evaluate the usage condition of the unconnected converter only with the internal temperature, and determine at least a converter having the lowest internal temperature as the additional converter. Further, for example, in a case where the power supply is excessive, the control unit 101 may evaluate the usage condition of the connected converter only with the internal temperature, and determine at least a converter having the highest internal temperature as the candidate converter. As a result, it is possible to realize operation in which an occurrence rate of failure or malfunction of the power supply system is reduced while avoiding a decrease in conversion efficiency.

### Second Modification

In the embodiment and the modification described above, the three types of the accumulated power generation time, the accumulated power generation amount, and the internal temperature are exemplified as the viewpoints of evaluating the usage condition of the DC/DC converter, but the implementation of the present invention is not limited thereto, and other items may be set as the viewpoints of evaluating the usage condition.

### Third Modification

In the embodiment described above, whether or not there is excess or insufficiency in the power supply with respect to the power demand is determined based on whether or not the output voltage measured by the voltmeter 133 is not included in the predetermined range, but the implementation of the present invention is not limited thereto. The presence or absence of excess or insufficiency may be determined based on other measurement values involved in the power supply system.

### Fourth Modification

In the embodiment described above, the connection state of the DC/DC converter selected based on the usage condition is changed when excess or insufficiency of the power supply with respect to the power demand is detected, but the implementation of the present invention is not limited thereto. The timing of changing the connection state of the DC/DC converter selected based on the usage condition may be, for example, another timing at which the connection state of the DC/DC converter is changed, such as timing at which the type (the solar power generator 121, the battery 122, the engine generator 123, and the like) of the operating power supply source is switched.

### Fifth Modification

In the embodiment described above, the specifications of the plurality of DC/DC converters 132 included in the power supply system are the same, but the embodiment of the present invention is not limited thereto, and it goes without saying that DC/DC converters having different specifications may be included.

### Sixth Modification

In the embodiment and the modifications described above, the aspect in which the present invention is applied to the off-grid power supply system has been described. However, the implementation of the present invention is not limited thereto, and the present invention can also be implemented, for example, in a microgrid power supply system or a power supply system configured to be able to cooperate with a grid. The present invention is applicable as long as the connection state of the DC/DC converter is controlled in order to control the power supply from the DC power supply source.

### Summary of Embodiments

The above embodiments disclose at least the following management device, management method, storage medium, and program.

1. The control device of the embodiments described above wherein:
a control device that changes a connection state between a power supply source and a plurality of DC/DC converters, the control device comprising:
an acquisition unit (S601) configured to acquire a usage condition of each of the plurality of DC/DC converters;
a selection unit (S703, S801) configured to select at least one DC/DC converter for switching a connection state based on the usage condition; and
a first control unit (S704, S804) configured to change the connection state between the power supply source and the plurality of DC/DC converters based on a selection result by the selection unit.

According to this embodiment, when the connection state between the power supply source and the plurality of DC/DC converters is to be switched, an appropriate DC/DC converter can be selected based on the usage condition.

2. The control device of the embodiments described above further comprising:
a detection unit configured to detect excess or insufficiency of power supply with respect to a power demand;
the selection unit (S703, S801) selects at least one DC/DC converter for switching the connection state, when it is detected the excess or insufficiency of power supply.

According to this embodiment, when the excess or insufficiency of the power supply with respect to the power demand occurs and the connection state of any DC/DC converter is to be switched, an appropriate DC/DC converter can be selected based on the usage condition.

3. The control device of the embodiments described above wherein:
the selection unit (S801) selects at least one DC/DC converter to be disconnected from among DC/DC converters which are connecting to the power supply source, when it is detected by the detection unit that the power supply is excessive.

According to this embodiment, when the power supply is excessive with respect to the power demand, an appropriate DC/DC converter can be selected as a disconnection target based on the usage condition.

4. The control device of the embodiments described above wherein:
the usage condition includes an accumulated power generation time of the DC/DC converter, and
the selection unit at least selects a DC/DC converter having the longest accumulated power generation time from among the DC/DC converters which are connecting to the power supply source as at least one DC/DC converter to be disconnected.

According to this embodiment, since the DC/DC converter having the long accumulated power generation time is preferentially disconnected, it is possible to realize operation in which the life of a power supply system is extended while causing deterioration situations of the plurality of DC/DC converters to be uniform.

5. The control device of the embodiments described above wherein:
the usage condition includes an accumulated power generation amount of the DC/DC converter, and
the selection unit selects, as the at least one DC/DC converter to be disconnected, at least a DC/DC converter having the largest accumulated power generation amount from among the DC/DC converters which are connecting to the power supply source.

According to this embodiment, since the DC/DC converter having the large accumulated power generation amount is preferentially disconnected, it is possible to realize operation in which the life of a power supply system is extended while causing deterioration situations of the plurality of DC/DC converters to be uniform.

6. The control device of the embodiments described above wherein:
the usage condition includes an internal temperature of the DC/DC converter, and
the selection unit selects, as the at least one DC/DC converter to be disconnected, at least a DC/DC converter having the highest internal temperature from among the DC/DC converters which are connecting to the power supply source.

According to this embodiment, since the DC/DC converter having the high internal temperature is preferentially disconnected, it is possible to realize operation in which an occurrence rate of failure or malfunction of a power supply system is reduced while avoiding a decrease in conversion efficiency.

7. The control device of the embodiments described above wherein:
the usage condition includes an accumulated power generation time, an accumulated power generation amount and an internal temperature of the DC/DC converter, and
the selection unit selects the at least one DC/DC converter to be disconnected in order of priority of a DC/DC converter having a long accumulated power generation time, a DC/DC converter having a large accumulated power generation amount and a DC/DC converter having a high internal temperature.

According to this embodiment, it is possible to realize operation in which a deterioration situation of the DC/DC converter is caused to be uniform and a decrease in conversion efficiency and an occurrence rate of failure or malfunction are reduced.

8. The control device of the embodiments described above wherein:
the selection unit (S703) selects at least one DC/DC converter to be newly connected from among DC/DC converters which are not connecting to the power supply source, when it is detected by the detection unit that the power supply is insufficient.

According to this embodiment, when the power supply is insufficient with respect to the power demand, an appropriate DC/DC converter can be selected as a connection target based on the usage condition.

9. The control device of the embodiments described above wherein:
the usage condition includes an accumulated power generation time of the DC/DC converter, and
the selection unit selects, as the at least one DC/DC converter to be newly connected, at least a DC/DC converter having the shortest accumulated power generation time from among the DC/DC converters which are not connecting to the power supply source.

According to this embodiment, since the DC/DC converter having the short accumulated power generation time is preferentially connected, it is possible to realize operation in which the life of a power supply system is extended while causing deterioration situations of the plurality of DC/DC converters to be uniform.

10. The control device of the embodiments described above wherein:
the usage condition includes an accumulated power generation amount of the DC/DC converter, and
the selection unit selects, as the at least one DC/DC converter to be newly connected, at least a DC/DC converter having the smallest accumulated power generation amount from among the DC/DC converters which are not connecting to the power supply source.

According to this embodiment, since the DC/DC converter having the small accumulated power generation amount is preferentially connected, it is possible to realize operation in which the life of a power supply system is extended while causing deterioration situations of the plurality of DC/DC converters to be uniform.

11. The control device of the embodiments described above wherein:
the usage condition includes an internal temperature of the DC/DC converter, and
the selection unit selects, as the at least one DC/DC converter to be newly connected, at least a DC/DC converter having the lowest internal temperature from among the DC/DC converters which are not connecting to the power supply source.

According to this embodiment, since the DC/DC converter having the low internal temperature is preferentially connected, it is possible to realize operation in which an occurrence rate of failure or malfunction of a power supply system is reduced while avoiding a decrease in conversion efficiency.

12. The control device of the embodiments described above wherein:
the usage condition includes an accumulated power generation time, an accumulated power generation amount, and an internal temperature of the DC/DC converter, and
the selection unit (S703) selects the at least one DC/DC converter to be newly connected in order of priority of a DC/DC converter having a short accumulated power generation time, a DC/DC converter having a small accumulated power generation amount, and a DC/DC converter having a low internal temperature.

According to this embodiment, it is possible to realize operation in which a deterioration situation of the DC/DC converter is caused to be uniform and a decrease in conversion efficiency and an occurrence rate of failure or malfunction are reduced.

13. The control device of the embodiments described above wherein:
the detection unit detects excess or insufficiency of the power supply based on whether or not a voltage at the downstream of the plurality of DC/DC converters falls within a predetermined range.

According to this embodiment, it is possible to detect whether or not excess or insufficiency of the power supply occurs based on drooping characteristic caused by the unbalance between load power and supply power.

14. The control device of the embodiments described above further comprising:
a second control unit (S702, S803) configured to control a power generation amount of a DC/DC converter which is connecting to the power supply source, wherein
when it is detected by the detection unit that the power supply is insufficient,
   the second control unit (S702) increases the power generation amount of the DC/DC converter which is connecting to the power supply source, and
   the selection unit (S703) selects at least one DC/DC converter to be newly connected to the power supply source on condition that the voltage at the downstream falls below a lower limit value of the predetermined range, when all DC/DC converters which are connecting to the power supply source have a maximum power generation amount.

According to this embodiment, it is possible to realize operation of a power supply system that operates the minimum DC/DC converters that satisfy the power demand.

15. The control device of the embodiments described above wherein:
when it is detected by the detection unit that the power supply is excessive,
   the selection unit (S801) temporarily selects a DC/DC converter to be disconnected from the power supply source based on the usage condition, and
   the second control unit (S802) decreases a power generation amount of the DC/DC converter to be disconnected, and
   the selection unit (S803) selects the DC/DC converter to be disconnected as a DC/DC converter to be disconnected from the power supply source on condition that the voltage at the downstream exceeds an upper limit value of the predetermined range, when the power generation amount of the DC/DC converter to be disconnected is a minimum power generation amount.

According to this embodiment, it is possible to realize operation of a power supply system that operates the minimum DC/DC converters that satisfy the power demand while reducing the operation load of the DC/DC converter that is a disconnection candidate.

16. The control device of the embodiments described above wherein:
the power supply source belong to an off-grid or microgrid power supply system.

According to this embodiment, it is possible to realize stable power supply in a long term under an environment where there is a restriction on the power supply.

17. The control method of the embodiments described above wherein:
a control method for changing a connection state between a power supply source and a plurality of DC/DC converters, the control method being executed by a control device and comprising:
   acquiring (S601) a usage condition of each of the plurality of DC/DC converters;
   selecting (S703, S801) at least one DC/DC converter for switching a connection state based on the usage condition; and
   changing (S704, S804) the connection state between the power supply source and the plurality of DC/DC converters based on a selection result in the selection.

According to this embodiment, when the connection state between the power supply source and the plurality of DC/DC converters is to be switched, an appropriate DC/DC converter can be selected based on the usage condition.

18. The storage medium of the embodiments described above is:
storing a program for causing a computer that changes a connection state between a power supply source and a plurality of DC/DC converters to execute:
   acquiring (S601) a usage condition of each of the plurality of DC/DC converters;
   selecting (S703, S801) at least one DC/DC converter for switching a connection state based on the usage condition; and
   changing (S704, S804) the connection state between the power supply source and the plurality of DC/DC converters based on a selection result in the selection.

According to this embodiment, when the connection state between the power supply source and the plurality of DC/DC converters is to be switched, an appropriate DC/DC converter can be selected based on the usage condition.

19. The program of the embodiments described above is:
for causing a computer that changes a connection state between a power supply source and a plurality of DC/DC converters to execute:
   acquiring (S601) a usage condition of each of the plurality of DC/DC converters;
   selecting (S703, S801) at least one DC/DC converter for switching a connection state based on the usage condition; and
   changing (S704, S804) the connection state between the power supply source and the plurality of DC/DC converters based on a selection result in the selection.

According to this embodiment, when the connection state between the power supply source and the plurality of DC/DC converters is to be switched, an appropriate DC/DC converter can be selected based on the usage condition.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A control device that changes a connection state between a plurality of types of power supply sources in which which power supply source is operated is controlled and a plurality of DC/DC converters, the control device comprising:
a specifying unit configured to specify that an operating power supply source among the plurality of types of power supply sources is switched;
a detection unit configured to detect excess or insufficiency of power supply with respect to a power demand;
an acquisition unit configured to acquire a usage condition of each of the plurality of DC/DC converters;
a selection unit configured to select at least one DC/DC converter for switching a connection state based on the usage condition; and
a first control unit configured to change the connection state between the plurality of types of power supply sources and the plurality of DC/DC converters based on a selection result by the selection unit, wherein
the usage condition includes an accumulated power generation time of the DC/DC converter, and
the selection unit selects a DC/DC converter having the longest accumulated power generation time from among the DC/DC converters connected to the plurality of types of power supply sources as at least one DC/DC converter to be disconnected, when it is specified by the specifying unit that the operating power supply source is switched or when it is detected by the detection unit that the power supply is excessive, and
the first control unit changes the connection state between the plurality of types of power supply sources and the plurality of DC/DC converters based on the selection result, when it is specified by the specifying unit that the operating power supply source is switched.

2. The control device according to claim 1, wherein
the usage condition further includes an accumulated power generation amount of the DC/DC converter, and
the selection unit selects, as the at least one DC/DC converter to be disconnected, at least a DC/DC converter having the largest accumulated power generation amount from among the DC/DC converters which are connecting to the plurality of types of power supply sources, instead of the DC/DC converter having the longest accumulated power generation time.

3. The control device according to claim 1, wherein
the usage condition further includes an internal temperature of the DC/DC converter, and
the selection unit selects, as the at least one DC/DC converter to be disconnected, at least a DC/DC converter having the highest internal temperature from among the DC/DC converters which are connecting to the plurality of types of power supply sources, instead of the DC/DC converter having the longest accumulated power generation time.

4. The control device according to claim 1, wherein
the usage condition further includes an accumulated power generation amount and an internal temperature of the DC/DC converter, and
the selection unit selects the at least one DC/DC converter to be disconnected from among the DC/DC converters having the longest accumulated power generation time in order of priority of a DC/DC converter having a large accumulated power generation amount and a DC/DC converter having a high internal temperature.

5. The control device according to claim 1, wherein
the selection unit selects at least one DC/DC converter to be newly connected from among DC/DC converters which are not connecting to the plurality of types of power supply sources, when it is specified by the specifying unit that the operating power supply source is switched or when it is detected by the detection unit that the power supply is insufficient.

6. The control device according to claim 5, wherein
the usage condition further includes an accumulated power generation time of the DC/DC converter, and
the selection unit selects, as the at least one DC/DC converter to be newly connected, at least a DC/DC converter having the shortest accumulated power generation time from among the DC/DC converters connected to the plurality of types of power supply sources.

7. The control device according to claim 5, wherein
the selection unit selects, as the at least one DC/DC converter to be newly connected, at least a DC/DC converter having the smallest accumulated power generation amount from among the DC/DC converters which are not connecting to the plurality of types of power supply sources.

8. The control device according to claim 5, wherein
the usage condition further includes an internal temperature of the DC/DC converter, and
the selection unit selects, as the at least one DC/DC converter to be newly connected, at least a DC/DC converter having the lowest internal temperature from among the DC/DC converters which are not connecting to the plurality of types of power supply sources.

9. The control device according to claim 5, wherein
the usage condition further includes an accumulated power generation amount, and an internal temperature of the DC/DC converter, and
the selection unit selects the at least one DC/DC converter to be newly connected in order of priority of a DC/DC converter having a short accumulated power generation time, a DC/DC converter having a small accumulated power generation amount, and a DC/DC converter having a low internal temperature.

10. The control device according to claim 1, wherein
the detection unit detects excess or insufficiency of the power supply based on whether or not a voltage at the downstream of the plurality of DC/DC converters falls within a predetermined range.

11. The control device according to claim 10, further comprising:
a second control unit configured to control a power generation amount of a DC/DC converter connected to the plurality of types of power supply sources, wherein
when it is detected by the detection unit that the power supply is insufficient,
the second control unit increases the power generation amount of the DC/DC converter connected to the plurality of types of power supply sources, and
the selection unit selects at least one DC/DC converter to be newly connected to the plurality of types of power supply sources on condition that the voltage at the downstream falls below a lower limit value of the predetermined range, when all DC/DC converters which are connecting to the plurality of types of power supply sources have a maximum power generation amount.

12. The control device according to claim 11, wherein
when it is detected by the detection unit that the power supply is excessive,
the selection unit temporarily selects a DC/DC converter to be disconnected from the plurality of types of power supply sources based on the usage condition, and
the second control unit decreases a power generation amount of the DC/DC converter to be disconnected, and
the selection unit selects the DC/DC converter to be disconnected as a DC/DC converter to be disconnected from the plurality of types of power supply sources on condition that the voltage at the downstream exceeds an upper limit value of the predetermined range, when the power generation amount of the DC/DC converter to be disconnected is a minimum power generation amount.

13. The control device according to claim 1, wherein
the plurality of types of power supply sources belong to an off-grid or microgrid power supply system.

14. A control method for changing a connection state between a plurality of types of power supply sources in which power supply source is operated is controlled and a plurality of DC/DC converters, the control method being executed by a control device and comprising:
specifying that an operating power supply source among the plurality of types of power supply sources is switched;
detecting excess or insufficiency of power supply with respect to a power demand;
acquiring a usage condition of each of the plurality of DC/DC converters;
selecting at least one DC/DC converter for switching a connection state based on the usage condition; and
changing the connection state between the plurality of types of power supply sources and the plurality of DC/DC converters based on a selection result in the selection, wherein
the usage condition includes an accumulated power generation time of the DC/DC converter,
when it is specified in the specifying that the operating power supply source is switched or when it is detected in the detection that the power supply is excessive, a DC/DC converter having the longest accumulated power generation time is selected as at least one DC/DC converter to be disconnected from among the DC/DC converters connected to the plurality of types of power supply sources in the selection, and
when it is specified in the specifying that the operating power supply source is switched, the connection state between the plurality of types of power supply sources and the plurality of DC/DC converters is changed based on the selection result in the control.

15. A computer-readable storage medium storing a program for causing a computer that changes a connection state between a plurality of types of power supply sources in which which power supply source is operated is controlled and a plurality of DC/DC converters to execute:
specifying that an operating power supply source among the plurality of types of power supply sources is switched;
detecting excess or insufficiency of power supply with respect to a power demand;
acquiring a usage condition of each of the plurality of DC/DC converters;
selecting at least one DC/DC converter for switching a connection state based on the usage condition; and
changing the connection state between the plurality of types of power supply sources and the plurality of DC/DC converters based on a selection result in the selection, wherein
the usage condition includes an accumulated power generation time of the DC/DC converter,
when it is specified in the specifying that the operating power supply source is switched or when it is detected in the detection that the power supply is excessive, a DC/DC converter having the longest accumulated power generation time is selected as at least one DC/DC converter to be disconnected from among the DC/DC converters connected to the plurality of types of power supply sources in the selection, and
when it is specified in the specifying that the operating power supply source is switched, the connection state between the plurality of types of power supply sources and the plurality of DC/DC converters is changed based on the selection result in the control.
